(19) United States
(12) Patent Application Publication
(10) Pub. No.: US 2003/0060914 A1
(43) Pub. Date: Mar. 27, 2003

(54) Production control apparatus, production control method and production control program

(75) Inventor: Hiroyuki Takeuchi, Tokyo (JP)

Correspondence Address: McDERMOTT, WILL & EMERY, 600 13th Street, N.W., Washington, DC, 20005-3096, US

(73) Assignee: Mitsubishi Denki Kabushiki Kaisha

(21) Appl. No.: 10/224,315

(22) Filed: Aug. 21, 2002

(30) Foreign Application Priority Data
Sep. 25, 2001 (JP) 2001-292038

(51) Int. Cl. G06F 19/00

(52) U.S. Cl. 700/109; 700/100

(57) ABSTRACT

A production control apparatus includes: a memory part which stores received-order information having registered therein, for each of the order numbers, the product type, quantity of outstanding orders, replied delivery time, or the like, as well as in-process information having registered therein, for each of the lot numbers, product type, in-process step, date of charging, scheduled shipping date, planned rate of passing items, quantity of passing items, quality level, expected rate of passing items, or the like; an input part which receives as inputs slight trouble level, intermediate trouble level, and serious trouble level; an information processing part which registers the slight trouble level, the intermediate trouble level, and the serious trouble level for each of the lot numbers to thereby prepare the latest in-process information based on the in-process information; and a display part which displays the received-order information or in-process information.

### BACKGROUND OF THE INVENTION

1. Field of the Invention

This invention relates to a production control apparatus for controlling products (a lot) to be manufactured through a plurality of working/processing steps.

2. Description of the Related Art

Conventionally, there is no means for reflecting a lot which gives rise to a quality trouble in a production schedule and a replied delivery time. For example, JP-A07-178654 (1995) discloses a conventional production control apparatus in which a measurement inspection part for performing measurement and inspection of products stores the inspection information which has been transmitted through communication lines and, based on this inspection information, a control information preparation part prepares the control information inclusive of the manufacturing progress information and the product quality information.

Since the conventional production control apparatus, production control method and production control program are constituted as described above, there is a drawback in that a lot which gives rise to a quality trouble is not reflected in the production schedule and the replied delivery time.

### SUMMARY OF THE INVENTION

This invention has been made to solve the above-described drawback and has an object of providing a production control apparatus, a production control method and a production control program in which the quality troubles that have occurred inclusive of those occurred in the past for all of the in-process lots as well as for the stocks ready for shipment are simply and easily clarified for each of the lots so that they can be timely reflected in the production schedule and the reply to the delivery time.

According to a first aspect of the present, there is provided a production control apparatus for controlling a lot to be manufactured through a plurality of steps together with the quality level of the lot, the apparatus including: a memory part for storing the received-order information for each order number and the in-process information for each lot number secured for the order number; an input part for inputting a trouble level showing a degree of quality level of the lot; an information processing part for registering the trouble level inputted into the input part, the registering being made into the quality level for each lot number, thereby preparing the in-process information; and a display part for displaying the received-order information or the in-process information.

Thus, the quality troubles that have occurred inclusive of those occurred in the past for each lot are easily clarified, thereby timely reflecting them in the production schedule and in making a reply to the delivery time.

According to a second aspect of this invention, there is provided a production control method in which a lot to be manufactured in a plurality of steps is controlled together with a quality level thereof based on received-order information and in-process information. The method includes: an inputting step for inputting a trouble level showing a degree of quality level of the lot; an information processing step for registering the trouble level, which is inputted at the inputting step, into the quality level for each lot number and for preparing the in-process information for the lot number secured for each order number in the received-order information; and a displaying step for displaying the received-order information or the in-process information.

Thus, the quality troubles that have occurred inclusive of those occurred in the past for each lot are easily clarified, thereby timely reflecting them in the production schedule and in making a reply to the delivery time.

According to a third aspect of this invention, there is provided a production control program in which a lot to be manufactured in a plurality of steps is controlled together with a quality level thereof based on received-order information and in-process information. The program includes: an inputting procedure for inputting a trouble level showing a degree of the quality level of the lot; an information processing procedure for registering the trouble level inputted at the inputting procedure, the registering being made into the quality level for each lot number, thereby preparing the in-process information for the lot number secured for each order number in the received-order information; and a displaying procedure for displaying the received-order information or the in-process information.

Thus, the quality troubles that have occurred inclusive of those occurred in the past for each lot are easily clarified, thereby timely reflecting them in the production schedule and in making a reply to the delivery time.

### BRIEF DESCRIPTION OF THE DRAWINGS

FIG. 1 is a block diagram showing an overall arrangement of a production control apparatus according to an embodiment 1 of this invention;

FIG. 2 is a table showing one example of received-order information as stored in a received-order information part;

FIG. 3 is a table showing one example of in-process information as stored in an in-process memory part;

FIG. 4 is a table showing one example of shipping schedule information as computed by the information processing part based on the received-order information and the in-process information;

FIG. 5 is a table showing one example of the in-process information which is the result of renewal after treatment of a quality trouble;

FIG. 6 is a table showing one example of the shipping schedule information after renewal as computed by the information processing part based on the received-order information and the in-process information; and

FIG. 7 is a table showing one example of the manufacturing period information as computed by the information processing part.

### DETAILED DESCRIPTION OF THE PREFERRED EMBODIMENTS

An embodiment of the present invention will be described below.

Embodiment 1

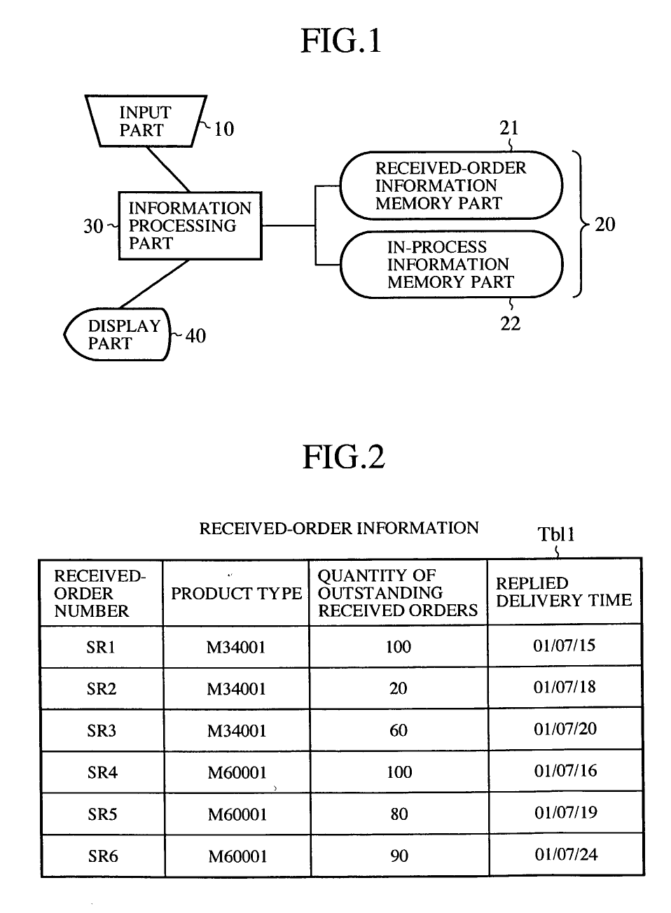

FIG. 1 is a block diagram showing an overall arrangement of a production control apparatus according to an embodiment 1 of this invention. This production control apparatus is constituted by a kind of computer system.

In FIG. 1, reference numeral 10 denotes an input part for registering and renewing a trouble level. Numeral 20 denotes a memory part for storing the information required for the production control and is made up of a received-order information memory part 21 and an in-process information memory part 22. Numeral 30 denotes an information processing part which prepares in-process information, shipping schedule information, and manufacturing period information based on that information in the memory part 20 which is required for the production control. Numeral 40 denotes a display part for displaying the information processed by the information processing part 30.

FIG. 2 is a table showing one example of received-order information Tbl1 stored in the received-order information memory part 21. In the received-order information Tbl1 in FIG. 2, there is registered the information required for the production control such as a product type, quantity of outstanding received orders, replied delivery time, or the like for each of the received-order numbers SR1 through SR6.

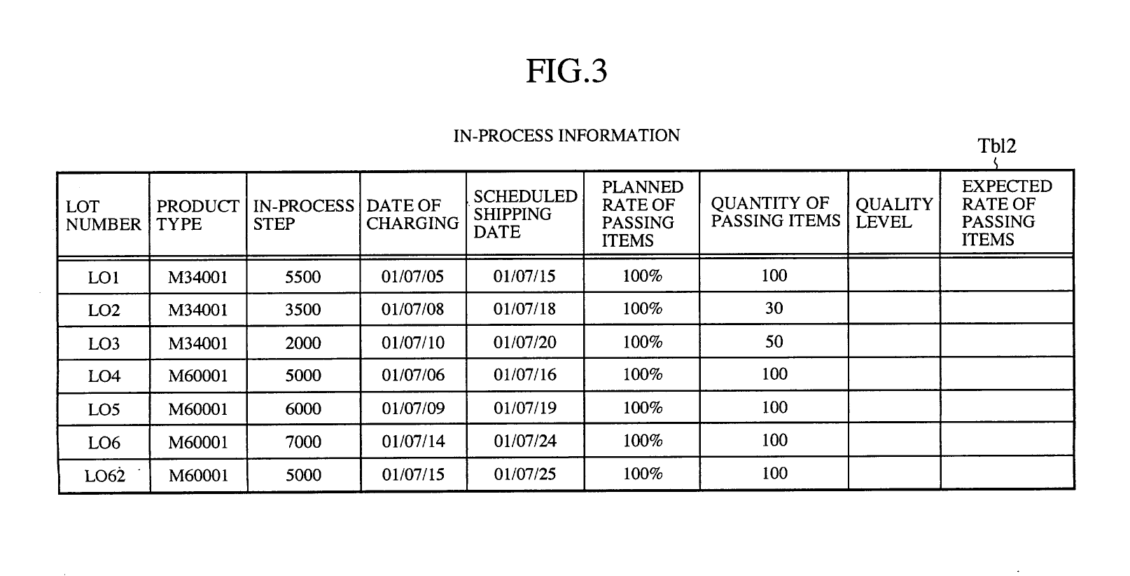

FIG. 3 is a table showing one example of the in-process information Tbl2 which is stored in the in-process information memory part 22. In the in-process information Tbl2 in FIG. 3, there is registered the information required for the production control such as the product type, in-process step, date of charging, scheduled shipping date, planned rate of passing items, quantity (number) of passing items, quality level, expected rate of passing items, or the like, for each of the lot numbers LO1 through LO6 and LO62. The quantity of passing items means the quantity of items that can be shipped, as computed by multiplying the latest quantity of in-process items by the planned rate of passing items. At this stage, since nothing is registered in the quality level, it is judged that each of lot numbers LO1 through LO6 and LO62 is expected to be completed as originally scheduled.

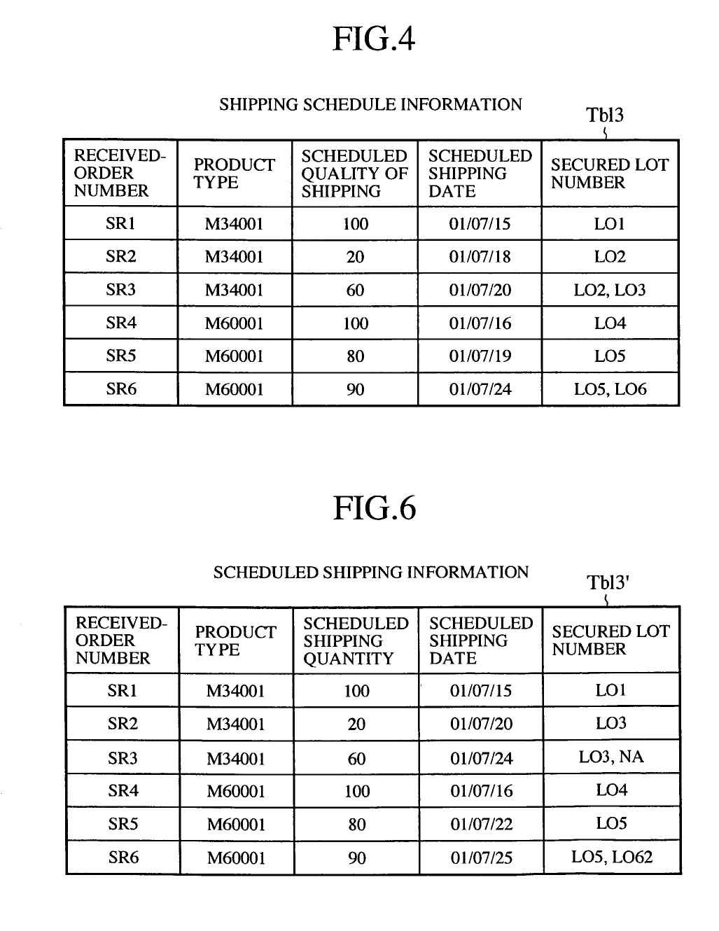

FIG. 4 is a table showing one example of the shipping schedule information Tbl3 before renewal which is prepared by the information processing part 30 based on the received-order information Tbl1 and the in-process information Tbl2. In the shipping schedule information Tbl3 in FIG. 4, there is registered the information required for the production control such as the product type, scheduled quantity of shipping, scheduled shipping date, secured lot number, or the like, for each of the received-order numbers SR1 through SR6. The information processing part 30 sequentially secures lot numbers LO1 through LO6 of nearer scheduled shipping date, starting with the one having a shorter replied delivery time from each of the received-order numbers SR1 through SR6, whereby the shipping schedule information Tbl3 is computed.

Under this kind of state, a description will now be made about how to treat in a case where a quality trouble happens in the following manner.

FIG. 5 is a table showing one example of that in-process information Tbl2′ in the in-process information memory part 22 which is the renewal result of treatment of the quality trouble.

A serious trouble has happened to the lot number LO2 and the entire lot number LO2 is deemed to result in failed items (quantity of passing items 30→0). In this case, a serious trouble level “S” is registered at the input part 10 into the quality level of the lot number LO2 in the in-process information memory part 22.

As a result of occurrence of a slight trouble to the lot number L05, a quality judgement has become necessary and, consequently, the scheduled shipping date will be delayed. In this case, a slight trouble “Q” is registered at the input part 10 into the quality level of the lot number LO5 in the in-process information memory part 22. At the same time, the originally scheduled shipping date (01/07/19) is changed to the latest-expected scheduled shipping date (01/07/22) at the input part 10.

An intermediate degree of trouble has happened to the lot number LO6 and the rate of passing items is deemed to worsen (lower) to about 50%. In this case, an intermediate trouble level “R” is registered at the input part 10 into the quality level of the lot number LO6 in the in-process information part 22, and an anticipated rate of passing items of 50% is registered at the input part 10.

As a result of the above, the present in-process items will run short in coping with the quantity of the remaining received-order (outstanding orders) in the received-order information Tbl1. Therefore, the information processing part 30 writes the quantity of charging (lot number LO7) to supplement the shortage, into the in-process information Tbl2′ in the in-process information memory part 22. The classification of the trouble levels need not be limited to the above-described three of light degree, intermediate degree, and serious degree, but may further be classed into various ones.

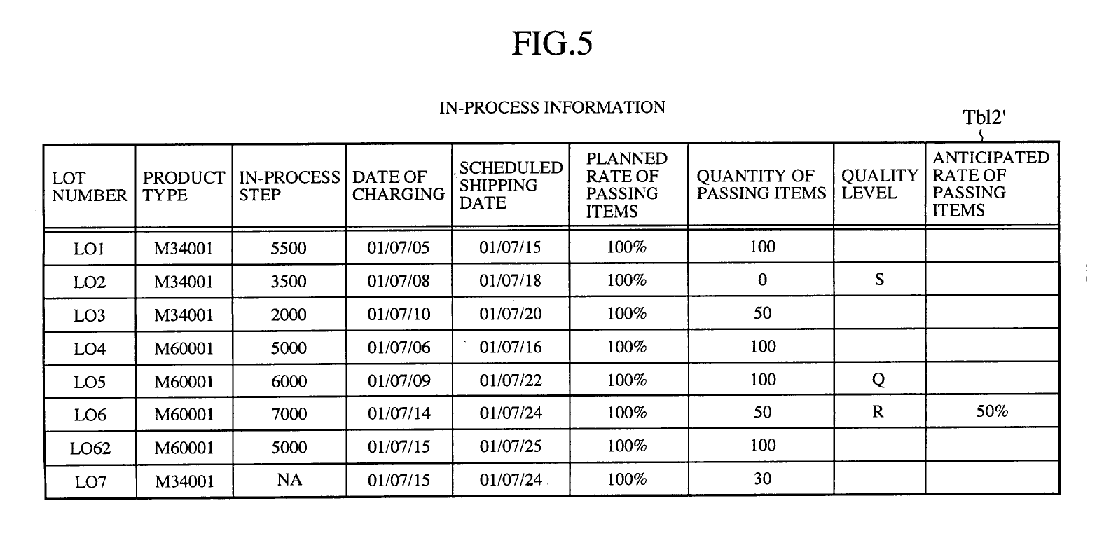

FIG. 6 is a table showing one example of the scheduled shipping information Tbl3′ after renewal as computed by the information processing part 30 based on the received-order information Tbl1 and the in-process information Tbl2′.

In the procedure of securing from the received-order information Tbl1 to the in-process lot, the lot number LO2 having the serious trouble level “S” in the quality level is not secured because it is not judged to belong to an effective in-process items (or inventory).

In addition, the lot number LO6 having the quality level “R” belongs to the intermediate-trouble lot though it belongs to an effective in-process inventory. Therefore, the order (sequence) of in-process securing from the received-order information Tbl1 is made by lowering the lot number LO6 next to the last-completed lot number among the presently in-processing lots. As a result, priority is given, in securing, to the lot number LO62 than to the lot number LO6. According to this arrangement, it becomes possible to secure the lot number that can be processed ordinarily and the received-order information Tbl1.

Further, there is shown above an example of preparing the latest shipping schedule information Tbl3′ which holds therein the received-order number and the secured (tied) information of the lot number. Therefore, in a case where a reply to the delivery time has been offered relative to the order number, the securing of the lot number to the order number is clear enough. It follows that the separation between the replied delivery time and the scheduled shipping date can be utilized as the number of days required for recovering the progress. The result will be different from the shipping schedule information Tbl3 in FIG. 4 where nothing is registered in the quality level.

By displaying, in the display part 40, the information of “not charged yet” in the in-process step in FIG. 5, it becomes possible to lead to the instruction for additional charging in case there has happened a shortage in in-process items.

In addition, by displaying, in the display part 40, the scheduled shipping quantity of the shipping schedule information Tbl3′ in FIG. 6, it becomes possible to grasp the latest scheduled shipping quantity.

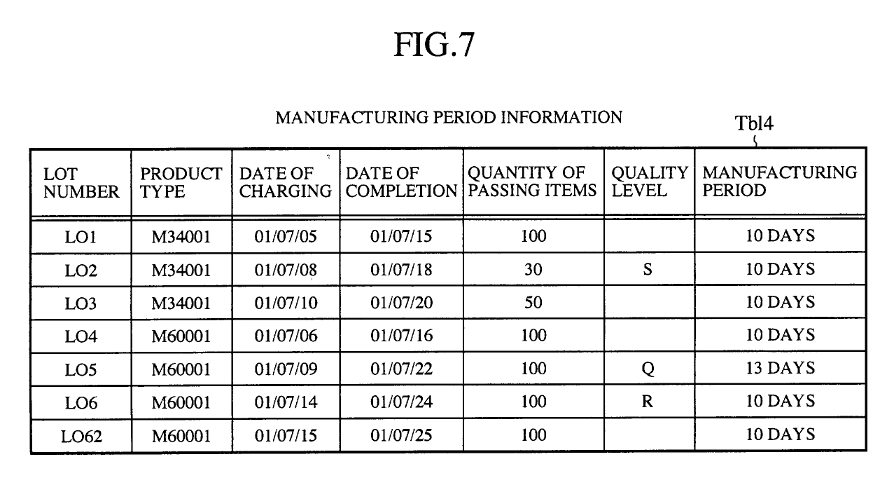

FIG. 7 is a table showing one example of the manufacturing period information Tbl4 as computed by the information processing part 30. This manufacturing period information Tbl4 is capable of being displayed in the display part 40. In the manufacturing period information Tbl4 in FIG. 7, there are registered the information required for the production control such as the product type, date of charging, date of completion, quantity of passing items, quality level, manufacturing period, or the like, for each of the lot numbers LO1 through LO6 and LO62. The manufacturing period is the number of days obtained by subtracting the date of charging from the date of completion. Ordinarily, an activity is made to shorten the manufacturing period. Commonly, the measures to be taken normally vary with where the problem with the present manufacturing period lies.

According to the production control apparatus of the embodiment 1, it becomes possible to isolate the problems to a certain degree. In concrete, the trouble level information registered in the quality level becomes the key to the isolation of the problems. The slight trouble level “Q” registered like in lot number LO5 in FIG. 7 is the lot number which has undergone a delay as a result of quality judgement. Therefore, what is required in shortening the manufacturing period is found to shorten the period of quality judgement. The isolation of the problems can thus be materialized by summarizing at the information processing part 30 the manufacturing period for each of the quality levels.

As described above, the production control apparatus according to the embodiment 1 is made up of the following, i.e.,: a memory part 20 which stores therein the received-order information Tbl1 having registered therein, for each of the order numbers SR1 through SR6, the product type, the quantity of outstanding orders, replied delivery time, or the like, as well as the in-process information Tbl2 having registered therein, for each of lot numbers LO1 through LO6 and LO62, product type, in-process step, date of charging, scheduled shipping date, planned rate of passing items, quantity of passing items, quality level, expected rate of passing items, or the like; an input part 10 which receives as inputs a slight trouble level “Q” in which the scheduled shipping date is delayed due to the necessity of the quality judgement, or the like, an intermediate trouble level “R” in which the rate of passing items is expected to lower to about 50%, and a serious trouble level “S” in which the entire lot is deemed to become failed items; an information processing part 30 which registers the slight trouble level “Q”, the intermediate trouble level “R”, and the serious trouble level “S” for each of the lot numbers LO2, LO5, LO6 to thereby prepare the latest in-process information Tbl2 based on the in-process information Tbl2; and a display part 40 which displays the received-order information Tbl1 or in-process information Tbl2, Tbl2′. Therefore, there is obtained an effect in that the quality troubles that have occurred to each lot inclusive of those occurred in the past are easily clarified so that they can be timely reflected in the production schedule and in making a reply to the delivery time.

In addition, according to the embodiment 1, when the latest estimate (01/07/22) is inputted into the input part 10 as the scheduled shipping date of the lot number LO5 in the slight trouble level “Q”, the information processing part 30 changes the scheduled shipping date of the lot number LO5 from the originally expected shipping date (01/07/19) to the latest expected date (01/07/22) to thereby prepare the in-process information Tbl2′ based on the in-process information Tbl2. Therefore, there is an effect in that the quality troubles that have occurred inclusive of those occurred in the past for each lot are easily clarified to thereby timely reflect them in the production schedule and in making a reply to the delivery time.

Further, according to the embodiment 1, when an anticipated rate of passing items of 50% in the lot number LO6 of the intermediate trouble level “R” is inputted into the input part 10, the information processing part 30 registers the anticipated rate of passing items of 50% of the lot number LO6 and prepares the in-process information Tbl2′ based on the in-process information Tbl2. Therefore, there is an effect in that the quality troubles that have occurred inclusive of those occurred in the past for each lot are easily clarified to thereby timely reflect them in the production schedule and in making a reply to the delivery time.

Further, according to the embodiment 1, in securing from the received-order information Tbl1 to the in-process lot, the information processing part 30 prepares the shipping schedule information Tbl3′ from the shipping schedule information Tbl3 by lowering the lot number LO6 of the intermediate trouble level “R” next to the last-completed lot number LO62 in the securing ordinal rank. Therefore, there is an effect in that the lot that can ordinarily be processed and the received-order information Tbl1 can be secured.

Furthermore, according to the embodiment 1, in securing from the received-order information Tbl1 to the in-process lot, the information processing part 30 prepares the shipping schedule information Tbl3′ based on the shipping schedule information Tbl3 without securing the lot number LO2 of serious trouble level “S.” Therefore, there is an effect in that the lot that cannot be processed and the received-order information Tbl1 need not be secured.

Still furthermore, according to the embodiment 1, in case the quantity of passing items in the in-process information Tbl2′ becomes short relative to the quantity of the outstanding orders in the received-order information Tbl1, the in-process information Tbl2′ is prepared by the information processing part 30 by adding the lot number LO7 which is the quantity of lot required to be charged for supplementing the shortage. Therefore, there is an effect in that the quality troubles that have occurred inclusive of those in the past for each lot are easily clarified, thereby timely reflecting them in the production schedule and in making a reply to the delivery time.

Furthermore, according to the embodiment 1, the information processing part 30 prepares manufacturing period information Tbl4 obtained by subtracting the date of charging a lot from the date of completion of the lot as summarized for each quality level. Therefore, by comparing the manufacturing period of the manufacturing period information Tbl4 with the quality level, the department responsible for the manufacturing period control index can be clarified.

What is claimed is:

1. A production control apparatus for controlling a lot to be manufactured through a plurality of steps together with its quality level based on received-order information and in-process information, said apparatus comprising:
a memory part for storing the received-order information for each order number and the in-process information for each lot number secured for the order number;
an input part for inputting a trouble level showing a degree of quality level of the lot;
an information processing part for registering the trouble level, which is inputted into said input part, to the quality level for each lot number, and preparing the in-process information; and
a display part for displaying the received-order information or the in-process information.

2. The production control apparatus according to claim 1, wherein, in case the quality level is in a trouble level showing a delay in a scheduled shipping date, said information processing part prepares in-process information in which the scheduled shipping date of the lot in said trouble level is changed from an originally expected schedule to a latest expected schedule.

3. The production control apparatus according to claim 1, wherein, in case the quality level is in a trouble level showing a decrease in a rate of passing items in a lot, said information processing part prepares in-process information in which an anticipated rate of passing items in the lot of said trouble level is registered.

4. The production control apparatus according to claim 1, wherein, in case the quality level is in a trouble level showing a decrease in a rate of passing items in a lot, said information processing part prepares scheduled shipping information in which a securing ordinal rank, relative to the received-order information, of the lot of said trouble level is lowered next to a last-completed lot.

5. The production control apparatus according to claim 1, wherein, in case the quality level is in a trouble level showing nonconformity of an entire lot, said information processing part prepares a scheduled shipping information without securing the lot of said trouble level relative to the received-order information.

6. The production control apparatus according to claim 1, wherein, in case the quantity of passing items in the in-process information becomes short relative to the quantity of outstanding orders in the received-order information, the information processing part prepares in-process information in which the quantity of lots to be charged to compensate for the shortage is added.

7. The production control apparatus according to claim 1, wherein the information processing part prepares manufacturing period information obtained by subtracting a date of charging a lot from a date of completion of the lot, said manufacturing period information being summarized for each quality level.
